(19) United States
(12) Patent Application Publication
(10) Pub. No.: US 2025/0384291 A1
(43) Pub. Date: Dec. 18, 2025

(54) INTELLIGENT WORKFLOW EVENT PREDICTION AND CONTINGENCY PLANNING

(71) Applicant: INTERNATIONAL BUSINESS MACHINES CORPORATION, Armonk, NY (US)

(72) Inventors: Mark J. LUDLOW, Fairfield, CT (US); Lucia Larise STAVARACHE, Columbus, OH (US); Sarah Diane GREEN, Chandler, AZ (US); Michael Jack MARTINE, Chapel Hill, NC (US); Stan Kevin DALEY, Espanola, NM (US); Ira L. ALLEN, Dallas, TX (US)

(21) Appl. No.: 18/743,354

(22) Filed: Jun. 14, 2024

(51) Int. Cl. G06N 3/092; G06Q 10/0633

(52) U.S. Cl. CPC G06N 3/092; G06Q 10/0633

(57) ABSTRACT

Computer implemented methods, systems, and computer program products include program code executing on a processor(s) generates scenarios based on cognitively analyzing external events. The processor(s) cognitively analyze the process and segmenting the process into components, and for each component: determine an endpoint for each component; determine the scenarios relevant to the component; adjust the endpoint of the component based on the scenarios relevant to the component; applying reinforcement learning to the scenarios relevant to the component to validate impacts of the scenarios on the endpoint and to select a most likely scenario; and implement process changes to terminate the component at the adjusted endpoint.

### BACKGROUND

The present invention relates generally to the field of intelligent workflows and in particular to increasing workflow efficiencies by iteratively adjusting endpoints based on event prediction and additional inputs to more efficiently reach the adjusted endpoints.

Artificial intelligence (AI) refers to intelligence exhibited by machines. Artificial intelligence (AI) research includes search and mathematical optimization, neural networks, and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

Large language models (LLMs) are deep learning models that are pre-trained on vast amounts of data. Transformer LLMs refer to LLMs that are capable of unsupervised training and can learn to understand basic grammar, languages, and knowledge. The underlying transformer for a transformer LLM is a set of neural networks that consist of an encoder and a decoder with self-attention capabilities. The encoder and decoder extract meanings from a sequence of text and understand the relationships between words and phrases in it. Unlike earlier recurrent neural networks (RNN) that sequentially process inputs, transformers process entire sequences in parallel. In addition to utilizing CPUs to train LLMs, data scientists can also use GPUs for training transformer based LLMs, significantly reducing the training time.

A Chain of Reasoning (CoR) refers to a logical progression of statements or arguments designed to reach a conclusion. Each step in the reasoning process is connected logically, with premises leading to a conclusion based on deductive or inductive reasoning.

Intelligent workflows combine automation, AI and analytics to adapt to different conditions, adjusting themselves as environments evolve.

### SUMMARY

Shortcomings of the prior art are overcome, and additional advantages are provided through the provision of a computer-implemented method for revising process endpoints by updating strategies based on predicting impacts of exogenous events on original endpoints. The method can include: generating, by one or more processors, scenarios based on cognitively analyzing external events; cognitively analyzing, by the one or more processors, the process and segmenting the process into components, for each component: determining an endpoint for each component; determining, by the one or more processors, the scenarios relevant to the component; adjusting, by the one or more processors, the endpoint of the component based on the scenarios relevant to the component; applying, by the one or more processors, reinforcement learning to the scenarios relevant to the component to validate impacts of the scenarios on the endpoint and to select a most likely scenario; and implementing, by the one or more processors, process changes to terminate the component at the adjusted endpoint.

Shortcomings of the prior art are overcome, and additional advantages are provided through the provision of a computer program product for revising process endpoints by updating strategies based on predicting impacts of exogenous events on original endpoints. The computer program product comprises a storage medium readable by a one or more processors and storing instructions for execution by the one or more processors for performing a method. The method includes, for instance: generating, by the one or more processors, scenarios based on cognitively analyzing external events; cognitively analyzing, by the one or more processors, the process and segmenting the process into components, for each component: determining an endpoint for each component; determining, by the one or more processors, the scenarios relevant to the component; adjusting, by the one or more processors, the endpoint of the component based on the scenarios relevant to the component; applying, by the one or more processors, reinforcement learning to the scenarios relevant to the component to validate impacts of the scenarios on the endpoint and to select a most likely scenario; and implementing, by the one or more processors, process changes to terminate the component at the adjusted endpoint.

Shortcomings of the prior art are overcome, and additional advantages are provided through the provision of a system for revising process endpoints by updating strategies based on predicting impacts of exogenous events on original endpoints. The system includes: a memory, one or more processors in communication with the memory, and program instructions executable by the one or more processors via the memory to perform a method. The method includes, generating, by the one or more processors, scenarios based on cognitively analyzing external events; cognitively analyzing, by the one or more processors, the process and segmenting the process into components, for each component: determining an endpoint for each component; determining, by the one or more processors, the scenarios relevant to the component; adjusting, by the one or more processors, the endpoint of the component based on the scenarios relevant to the component; applying, by the one or more processors, reinforcement learning to the scenarios relevant to the component to validate impacts of the scenarios on the endpoint and to select a most likely scenario; and implementing, by the one or more processors, process changes to terminate the component at the adjusted endpoint.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 is a workflow that provides an overview of various aspects performed by the program code (executing on one or more processors) in some embodiments of the present disclosure;

FIG. 3 is a workflow that provides an overview of various aspects performed by the program code (executing on one or more processors) in some embodiments of the present disclosure;

FIG. 4 illustrates an existing strategy decision system which cannot anticipate impacts of exogenous events and trends and how these items can diverge from existing strategies and goals;

FIG. 5 illustrates aspects of the examples herein which can anticipate impacts of exogenous events and trends on existing strategies and goals;

FIG. 6 is a workflow that provides an overview of various aspects performed by the program code (executing on one or more processors) in some embodiments of the present disclosure; and

FIG. 7 illustrates aspects of a workflow and parts of a technical architecture that perform various aspects of some embodiments of the present disclosure.

### DETAILED DESCRIPTION

Enterprises and organizations create business strategies and execution plans to realize their desired organizational objectives. These strategies can become outdated, irrelevant, or less relevant, by the time the execution plan is implemented. Certain changes, which would render an outdated plan useable, can be anticipated and managed to effectively, but unanticipated changes such as unanticipated external events, changes in business conditions, and invalidated strategic assumptions, cannot be predicted using current method and render plans (workflows, processes) ineffective over time. Hence, there is a need for an ability to extrapolate future conditions to evaluate scenarios that could potentially happen and to develop contingency plans to mitigate such emerging conditions. Presently, a method exercise called a “pre-mortem” utilizes imagination and knowledge of people familiar with the business strategy, market conditions, and current operations to imagine what could go wrong in the future. In anticipation of these potential future events, businesses can develop contingent strategies to counter the events' impact on how said strategy may be successfully realized. Unfortunately, although human imagination is arguably unlimited (albeit not accuracy and relevancy), time and energy devoted to such exercises is very limited, and a more robust contingency planning is not possible with the human mind as the only tool. The examples herein therefore leverage resources inextricably tied to computing to achieve a type of contingency planning that provides significantly more than using present approaches which rely on human resources (imagination).

The examples herein revise workflow or process endpoints based on updating strategies based on predicting impacts of exogenous events. The examples herein utilize resources inextricably tied to computing including consultative AI agents comprised of program code executing on one or more processors which: 1) generates and evaluates future potential events; 2) calculates a net present value of impacts of these events; 3) suggests mitigations that can optimize the chances of reaching a desired conclusion (including having a business strategy succeed), and/or 4) automatically executes the mitigations. As unplanned external changes cause the need for changes to the business, it is desirable to get to the right strategy and execution sooner and more reliably, with a higher degree of success. While using generative AI to discover exogenous events that could not be anticipated by humans is helpful, it can be insufficient for reliability and hence, the examples herein utilize both generative AI and chain of reasoning. Program code in the examples herein utilizes generative AI to articulate conditions and events and chain of reasoning interaction with humans to determine the viability of conditions and events. Program code in the examples herein enable users to interact with articulations of the generative AI and utilizes an interaction chain of reasoning to reach a reliable outcome more efficiently.

Advantages of implemented the examples herein are both direct and useful. As will be discussed in greater detail herein, program code in the examples herein employs generative AI agent to consider a multitude of contingencies without succumbing to logic fallacies, fatigue, or a human bias towards determining at the outset that something is impossible in the aggregate. Inputs and training data can include existing ideas, experiences, prior learnings, scholarly writing, innovations, and a broad range of published works. The examples herein can be utilized to augmentation of human decision making because in some examples, generative AI agents do not make the decision regarding how to mitigate a potential future event, rather program code utilizing generative AI can inform users utilizing a chain of reasoning. The user can decide to course-correct within the development of a new strategy, resulting in a plethora of optimization implementations. In some examples, based on the decision, the program code can automatically implement mitigations provided by the program code.

The computer-implemented methods, computer program products, and systems described herein include computer code executing on one or more processors that concurrently with executing a process (e.g., a workflow) anticipate events external to the process that could impact the process, anticipate the impacts on the process of those events, and determine based on the connectivity of the elements, systems, and components involved in the process, how the anticipated external events will impact the systems executing the process on a granular level. Because of the insights and advance information provided by the program code, including on this granular level, the program code can provide a chain of reasoning artificially intelligent workflow to enable users to strategize around unplanned events. The examples can include program executing on one or more processors integrating Chain of Reasoning (CoR), Component Business Model (CBM) methodology, and Large Language Models (LLMs) into framework for navigating strategic business transformation. The program code can utilize CBM to dissect a business (including a process, workflow, hardware and software infrastructure) into manageable components and can apply CoR to assess the systems. The program code can utilize LLMs to simulate impacts of external events on these components. The program code can incorporate reinforcement learning to iteratively refine future scenarios inclusive of success metrics, benchmarks, and regulations. The program code can integrate CBM benchmarks, heatmaps, and assessments to strengthen CoR steps. Thus, the program code can provide a structured and a measurable way to evaluate and visualize transformations to ensure alignment with strategic goals.

The examples herein are directed to various practical applications because they enable users to anticipate events and understand the impacts of these anticipated events, therefore enabling business continuity and assisting in the management and design of robust systems to accomplish various objectives. For example, program code in the examples herein can enable a user or system to arrive at the end of a given process more quickly, while throughout the process ensuring that the conclusion is a desired and/or otherwise correct outcome. The program code in the examples herein can leverage AI to determine how unplanned external events (including but not limited to black swan events) are going to impact businesses, including enterprise computing systems utilized by businesses. The program code in the examples herein can identify and anticipate impacts to processes and workflows based on both anticipating formerly unforeseen events and determining connections between components and thus, understanding impacts on the components themselves and on those to which they are connected.

The examples herein leverage various existing technologies which are inextricably tied to computing and are directed to the practical application of minimized process disruptions based on anticipating events that could impact the process, including at a component level. For example, some of the systems, computer program products, and computer-implemented method herein integrate Chain of Reasoning (CoR), Component Business Model (CBM) methodology, and Large Language Models (LLMs) into a framework for strategic process transformation. A CoR supports multi-step and dynamic reasoning on changed relations and objects. Program code executing on one or more processors utilizing CoR can detail, iteratively, the relational reasoning operations form new relations between objects, and the object refining operations and can generate new compound objects from relations. CBM is a technique that can be utilized by program code executing on one or more processors to model and analyze an enterprise. For example, the program code can generate a logical representation or map of business components or building blocks and the program code can generate a compact visualization of the components, for example, by displaying the map on a single page or fitted to a single digital display in a graphical user interface (GUI). As aforementioned, LLMs are deep learning models that are pre-trained on vast amounts of data. The examples herein utilize a combination of generative AI and LLMs which are both inextricably tied to computing.

Among other significant advantages over existing approaches to expanding and accelerating strategy curation and movement to execution is the unique combination of elements utilized to accomplish this and other practical applications. For example, some of the examples herein integrate CBM and CoR frameworks by utilizing CBM to dissect a business (e.g., including a technical infrastructure of the business) into manageable components and apply CoR for a systematic assessment of each of these components. The program code in the examples herein can generate dynamic scenarios utilizing LLMs, for example, by utilizing the predictive power of LLMs to simulate the impact of external events on the components. The program code can also optimize reinforcement learning-enhanced scenarios. The program code in the examples herein can incorporate reinforcement learning to iteratively refine predicted scenarios inclusive of success metrics, benchmarks, and regulations. The examples herein can also utilize CBM-driven benchmarks, heatmaps, and assessments. Certain of the examples herein include integrated CBM benchmarks, heatmaps, and assessments to strengthen the CoR elements of the examples. The examples herein can also include Human-AI collaborative decision-making because the program code in these examples can establish a feedback loop between human expertise and AI-generated insights. Thus, the examples herein can provide a unique combination for strategic transformations and by integrating CoR, CBM, and LLMs, the examples herein offer a unique and comprehensive framework for navigating transformations, including business and system transformations.

The systems, computer program products, and computer-implemented methods described herein provide significantly more than existing approaches to using a chain of reasoning AI workflow for creating a strategy around unplanned events. Creating a strategy around unplanned events is a practical application to which the examples herein are directed. Existing approaches do not include program code that integrates CoR, CBM methodology, and LLMs into a framework for navigating strategic business transformation. Existing approaches also do not include utilizing CBM to dissect a business into manageable components and apply CoR for systematic assessment, which is an element of certain of the examples herein. The present examples (not existing approaches) utilize LLMs to simulate the impact of external events on components. Also, only the examples herein incorporate reinforcement learning to iteratively refine future scenarios inclusive of success metrics, benchmarks, and regulations. As another non-limiting examples, the examples herein provide significantly more because existing approaches do not integrate CBM benchmarks, heatmaps, and assessments to strengthen CoR steps, providing a structured and measurable way to evaluate and visualize transformations to ensure alignment with strategic goals.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

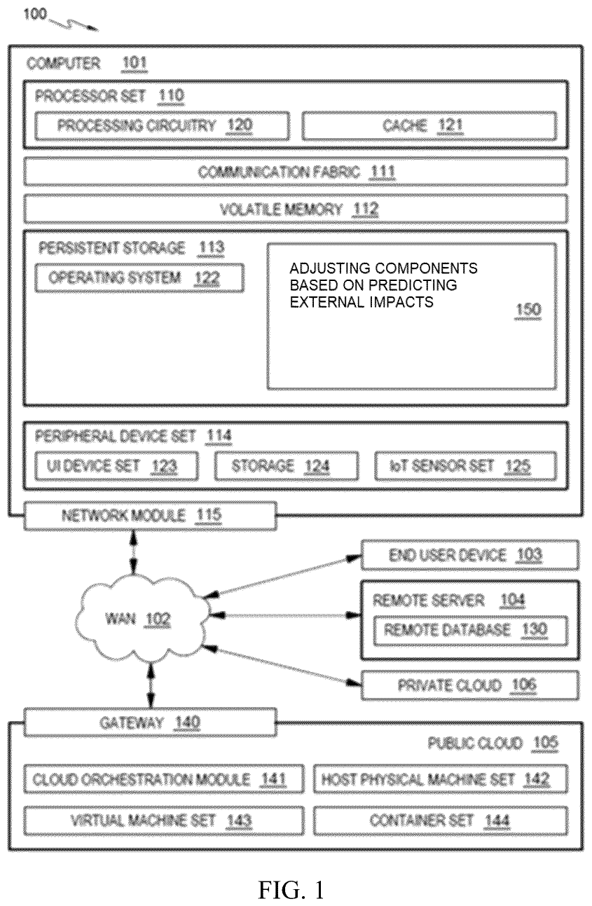

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block for adjusting process components based on predicting external impacts 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Neural networks, which are utilized in certain of the examples herein, refer to a biologically inspired programming paradigm which enables a computer to learn from observational data. This learning is referred to as deep learning, which is a set of techniques for learning in neural networks. Neural networks, including modular neural networks, are capable of pattern recognition with speed, accuracy, and efficiency, in situations where data sets are multiple and expansive, including across a distributed network of the technical environment. Modern neural networks are non-linear statistical data modeling tools. They are usually used to model complex relationships between inputs and outputs or to identify patterns in data (i.e., neural networks are non-linear statistical data modeling or decision-making tools). In general, program code utilizing neural networks can model complex relationships between inputs and outputs (including inputs and outputs of various components in an enterprise computing system) identify patterns in data and identify relationships between the components. Because of the speed and efficiency of neural networks, especially when parsing multiple complex data sets, neural networks and deep learning provide solutions to many problems in image recognition, speech recognition, and natural language processing, enabling relationships between components in a system to be more transparent. Neural networks can model complex relationships between inputs and outputs to identify patterns in data, including in images, as well as relationships and dependencies between components. In the examples herein, the program code can utilize CNNs and/or RNNs to expand and accelerate strategy curation and movement into execution.

In certain embodiments of the present invention the program code utilizes a CNN. CNNs are so named because they utilize convolutional layers that apply a convolution operation (a mathematical operation on two functions to produce a third function that expresses how the shape of one is modified by the other) to the input, passing the result to the next layer. The convolution emulates the response of an individual neuron to visual stimuli. Each convolutional neuron processes data only for its receptive field. It is generally not practical to utilize general (i.e., fully connected feedforward) neural networks to process data rich objects, as very high number of neurons would be necessary, due to the very large input sizes associated with larger files. Utilizing a CNN addresses this issue as it reduces the number of free parameters, allowing the network to be deeper with fewer parameters, as regardless of the file size, the CNN can utilize a consistent number of learnable parameters because CNNs fine-tune large amounts of parameters and massive pre-labeled datasets to support a learning process. CNNs resolve the vanishing or exploding gradients problem in training traditional multi-layer neural networks, with many layers, by using backpropagation. Thus, CNNs can be utilized in large-scale recognition systems, giving state-of-the-art results in segmentation, object detection, and object retrieval.

In certain embodiments of the present invention the program code utilizes an RNN. An RNN is a class of NN where connections between units form a directed cycle to exhibit dynamic temporal behavior. Unlike feedforward NNs, RNNs can use their internal memory to process arbitrary sequences of inputs. For this reason, current applications of RNNs include unsegmented data recognition, connected handwriting recognition, and speech recognition. These types of insights are useful in understanding relationships between components as well as impacts on components across different data sources.

An LLM is a deep learning model. Program code in the examples herein can implement a deep learning model in various forms such as by a neural network (e.g., a CNN, an RNN); LLMs are generally implemented using an NN. In some examples, a deep learning model includes multiple layers, each layer comprising multiple processing nodes. In some examples, the layers process in sequence, with nodes of layers closer to the model input layer processing before nodes of layers closer to the model output. Thus, layers feed to the next. Interior nodes are often “hidden” in the sense that their input and output values are not visible outside the model.

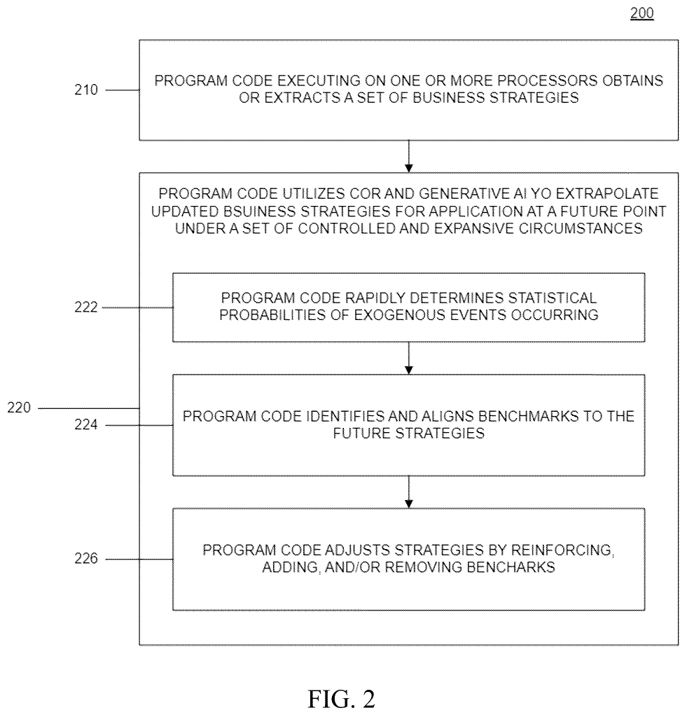

FIG. 2 illustrates a general workflow 200 of some of the examples herein. As illustrated in FIG. 2, program code executing on one or more processors extracts or obtains a set of business strategies (210). In some examples the program code obtains an existing set of business strategies. From the existing business strategies, the program code utilizes generative AI and a CoR to extrapolate updated strategies for application at a future point under a set of controlled and expansive circumstances (220). In order to extrapolate the updated strategies, the program code rapidly determining a statistical probability of exogenous events occurring (e.g., black swan events) (222). The program code identifies, selects and aligns benchmarks to the future strategy (224). The program code adjusts the strategies, based on the benchmarks (to generate the updated strategies) by reinforcing, adding, or removing benchmarks (226).

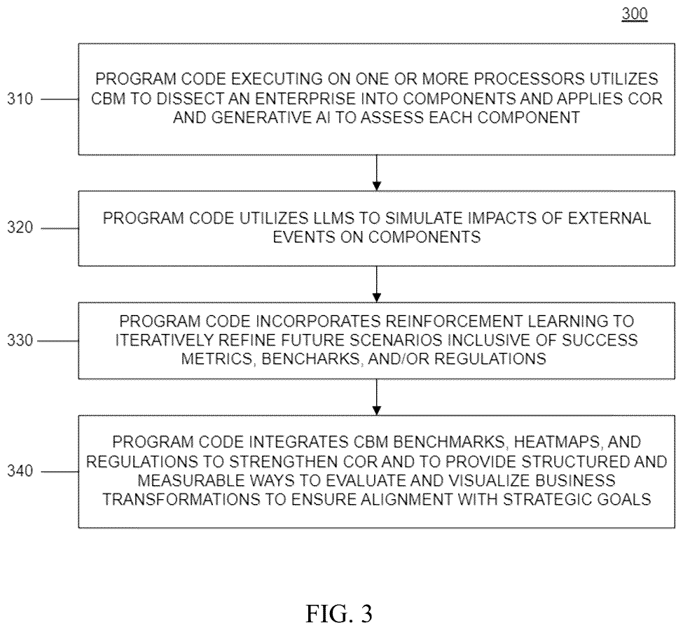

This invention involves an interactive intelligent workflow that consists of a system and method that improves the execution of a strategy. FIG. 3 illustrates how certain examples comprise generative AI systems that incorporate CoR, CBM methodology, and LLMs into a framework for strategic business transformation. FIG. 3 is a workflow 300 that provides additional details regarding the technical framework employed by the program code to perform various aspects of the examples herein. Program code executing on one or more processors utilizes CBM to dissect an enterprise into manageable components and applies CoR and generative AI to assess each component (310). The fusion between CBM and CoR ensures a thorough and logical evaluation of the “as-is” and “to-be” operating models, which will enhance decision-making precision. The program code utilizes LLMs to simulate impacts of external events on the components (320). The predictive aspects of LLMs enable the program code to simulate impacts of external events on the components, which enhances strategic forecasting. Through usage, an LLM is tailored by human input and reinforcement learning to predict possible events (with appropriate guard rails). The program code incorporates reinforcement learning to iteratively refine future scenarios inclusive of success metrics, benchmarks, and/or regulations (330). As aforementioned, utilizing CBM and CoR together, enables the program code to determine both “as-is” and “to-be” operating models. The program code utilizes reinforcement learning to iteratively refine the “to-be” scenarios to include success metrics, benchmarks and regulations. The program code can optimize strategic outcomes by aligning them closely with organizational objectives and external realities. The program code continuously evaluates multiple (e.g., millions of) future events. The program code determined a probability of each future event, determines a net present value (NPV) and an impact on strategy of each event based on methodically applying generative AI and CoR validations. The program code can expose inflection points, including those that cannot be anticipated without the use of this technological combination. The program code integrates CBM benchmarks, heatmaps, and assessments to strengthen CoR steps to provide structured and measurable ways to evaluate and visualize business transformations to ensuring alignment with strategic goals (340). Integrates CBM benchmarks, heatmaps, and assessments to strengthen the CoR steps provides users with a structured and measurable way to evaluate and visualize a transformation journey (how the end point changes based on the predicted impacts of the predicted events), ensure alignment with strategic goals, identify benchmarks that should no longer be considered as part of the strategy, identify additional meaningful indicators, and determine statical relationships between disparate components. Providing these visuals to a user enables a user to work with the AI to both select and appreciate next steps in view of the anticipated impacts. As aforementioned, the user can guide the process and make decisions regarding whether to implement mitigation measures, including those suggested by the program code. This collaboration between a user and the AI systems in the examples herein establishes a feedback loop between human expertise and AI-generated insights. This collaboration enables the strategic direction to benefit from both the nuanced understanding of human decision-makers and the computational power of the generative AI agent. Thus, the examples herein can augment insights of strategists by performing complex analyses and calculations related to business strategy on a scale that human decision-makers cannot perform.

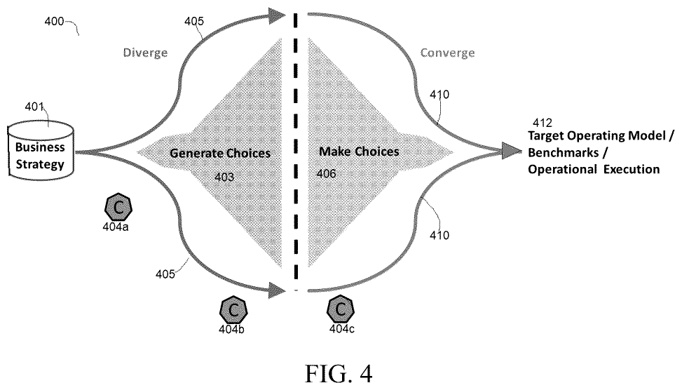

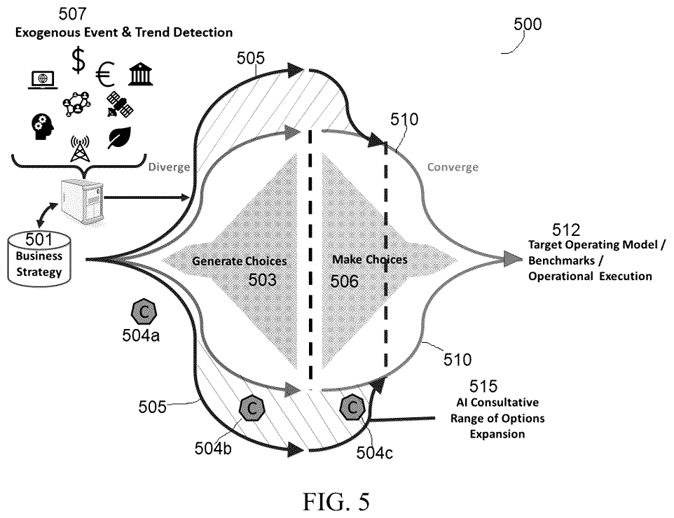

FIGS. 4 and 5 demonstrate how integration of the examples herein impacts strategy curation and movement into execution. To provide this contrast, FIG. 4 illustrates an existing strategy decision system which cannot anticipate impacts of exogenous events and trends and how these items can diverge from existing strategies and goals. In FIG. 4, program code obtains business strategies 401 and the program code can generate scenarios or choices (403) which, together with known constraints 404a-404c, create a divergence from a target (405). Based on making choices (406), the program code can create a convergence (410) to a target operating model, benchmarks, and/or operational execution 412.

The differences between FIGS. 4 and 5 highlight various advantages of the present examples over existing methods. FIG. 5 illustrates aspects of the examples herein which can anticipate impacts of exogenous events and trends on existing strategies and goals. Specifically, in FIG. 5, the program code, in addition to obtaining the business strategies 501, also obtains and detects exogenous events and trends 507. As illustrated in FIG. 5, the program code determines that the exogenous events and trends 507 cause additional divergence from the generated choices 503 (scenarios) and are also limited by the known constraints 504a-504c. Thus, the program code generates a wider berth of choices (503) (e.g., event scenarios) based on the additional information and predictions in view of this information from which the program code (with a user optionally included in the workflow) can make choices (506). FIG. 5 illustrates how program code in the examples herein, based on consulting with AI, generates an expanded range of options (515). To attain the convergence to (510) to a target operating model, benchmarks, and/or operational execution 512, the program code can apply CoR as well as utilize LLMs to confer to a user to select options based on benchmarks visualized by the program code.

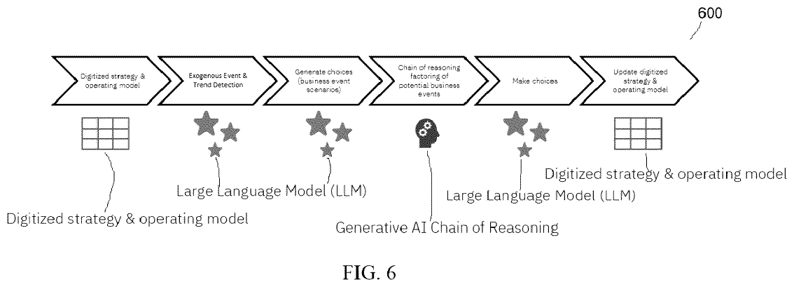

FIG. 6 illustrates a reduction to practice of various aspects of the examples herein and illustrates how the various aspects piece together to improve workflow outcomes. In FIG. 6, a digitized strategy and operating model 602 is first adjusted by program code executing by one or more processors when the program code applies one or more LLM to perform exogenous event and trend detection 604. The program code, applying the LLM, will generate choices 606 (e.g., event scenarios). The program code utilizes generative AI combined with CoR to perform chain of reasoning factoring of potential business events 608. The program code then applies the LLM to enable a user to make choices (having visualized these potential business events to the user) 610. The program code will then update the digitized strategy and operating model 612.

A combination of generative AI and CoR enables program code to predict events, impacts, and adjust end goals of workflows and processes, based on these predictions. A CoR is a logical progression of statements or arguments designed to reach a conclusion. Each step in the reasoning process is connected logically, with premises leading to a conclusion based on deductive or inductive reasoning. CoR is typically used in contexts requiring logical analysis and decision-making, such as scientific research, legal arguments, and philosophical debates. The structure of a CoR is logical because it follows a structured approach where each step is logically connected to the next, and it is often used in problem-solving, mathematical proofs, and scientific research. A CoR is objective because it is often evaluated based on the validity and soundness of the arguments (independent of personal feelings or experiences). A directed outcome in CoR refers to a process reaching a specific conclusion, solving a problem, or proving a hypothesis. A CoR utilizes analytical thinking which means that critical thinking and analytical skills are utilized to evaluate arguments, to identify logical fallacies, and to construct coherent arguments. The structure of CoR follows a logical progression aimed at a conclusion. An objective CoR focuses on objectivity and logical connections between premises and conclusions. Below is pseudocode that is included to provide insights into CoR and how it can be implemented in various examples herein.
asIsCBMModelStrategy=inputCurrentModel( )
externalEvents=identifyExternalEvents( )
scenarios=[ ]
for each event in externalEvents:
   impact=predictImpactWithAI(event, asIsCBMModelStrategy)
   toBeScenarios=generateToBeScenarios(impact)
   for scenario in toBeScenarios:
      simulateScenario(scenario)
      reward=evaluateScenario(scenario)
      refineScenario(scenario, reward)
   scenarios.append(toBeScenarios)
rankedScenarios=rankScenarios(scenarios)
optimalScenario=selectOptimalScenario(rankedScenarios)
transitionPlan=developTransitionPlan(optimalScenario)
implementPlan(transitionPlan)
monitorAndAdapt(transitionPlan)

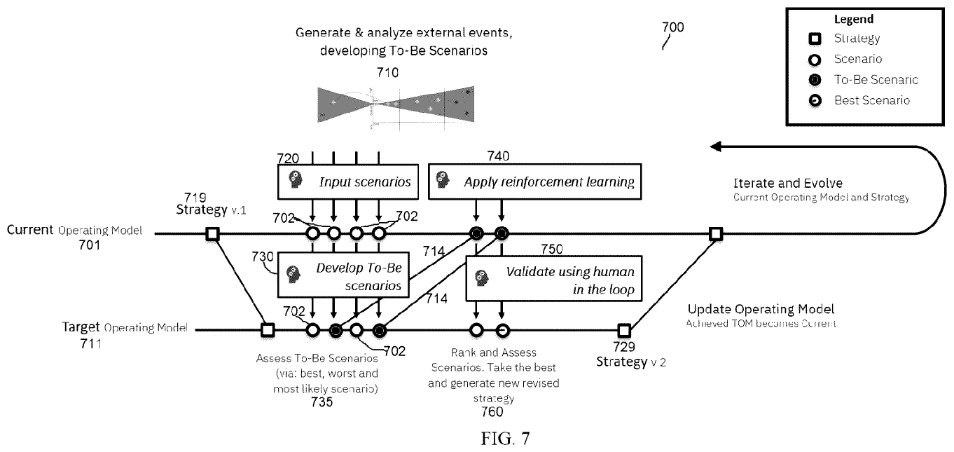

FIG. 7 illustrates the consultive AI (human and LLM/CoR/CBM/generative AI collaboration) intelligent workflow 700 achieved by program code in some of the examples herein. Aspects of the pseudocode provided above are illustrated in this workflow 700. As aforementioned, the consultive AI utilized by the program in the examples herein uses CoR in its decision-making process. Program code in the examples herein utilizes scenarios generated by AI and user (human) intelligence/experience to adjust an operating model, appreciating the different between the current operating model 701 and a more likely target operating model 711, given anticipated scenarios. FIG. 7 illustrates how the program code adjusts an initial strategy (strategy v.1 719) to become a new strategy (strategy v.2 729) as the target operating model 711 becomes the current operating model 701.

As illustrated in FIG. 7, program code utilizes generative AI to obtain, to analyze external events and generates scenarios 702 (program code will later determine which of these scenarios are “to-be” scenarios 714) (710). The program code inputs (720) these scenarios 702, which are possibilities, and utilizes CoR to develop “to be” scenarios which include assessing which of the scenarios are “to-be” scenarios 714, based on the current operating model 701 and in view of the strategy 719 (730). In assessing the scenarios to determine which scenarios to further evaluate based on being “to-be” scenarios (most likely to occur), the program code assesses the input scenarios to determine the best, worst and most likely scenarios (735). The program code can utilize a trained classifier that was trained on historical data to make this assessment. The target operating model 711 differs from the current operating model 701 and the space between them reflects the changes in strategy based on anticipated impacts of certain scenarios. The program code applies reinforcement learning to the “to-be” scenarios 714 (740) and enables a user to validate (make a decision based on the program code predicting impacts and providing mitigation actions) the “to-be” scenarios, noted as the program code validating using a human in the loop (750). In validating the scenarios, the program code, in cooperation with the user (the is an AI and human collaborative approach) can rank and assess the scenarios, select the best scenario (in view of the revised strategy v.2 729) (760). The program code then updates the operating model such that the target operating model 711 becomes the current operating model 701 (770). The strategy change from the strategy version 1 719 to the strategy version 2 729 is reflected in this change. As illustrated in FIG. 7, this process is iterative and evolves through continued utilization of the underlying systems (780).

The examples here comprise program code that can perform intelligent workflow managing, sensing, possibility generating, choice narrowing, and suggestion recommending. The program code can obtain current benchmarks via an AI service and also obtain strategies. The program code can suggest adjustments, based on utilizing CoR in addition to generative AI, and interact with users via at LLM to update benchmarks. The program code can then push the updated benchmarks.

In some of the examples of the computer-implemented methods, computer program products, and computer systems herein comprise program code executing on one or more processors generates scenarios based on cognitively analyzing external events. The program code cognitively analyzes the process and segments the process into components. For each component, the program code determines an endpoint for each component, the program code determines the scenarios relevant to the component, the program code adjusts the endpoint of the component based on the scenarios relevant to the component, the program code applies reinforcement learning to the scenarios relevant to the component to validate impacts of the scenarios on the endpoint and to select a most likely scenario, and the program code implements process changes to terminate the component at the adjusted endpoint.

In some examples, the components comprise software and hardware engaged in an aspect of the process.

In some examples, the components comprise components of an enterprise computing system.

In some examples, the program code cognitively analyzing the process and segmenting the process into the components comprises the program code applying component business model methodology.

In some examples, the program generating the scenarios based on cognitively analyzing external events comprises the program code utilizing a large language model to detect trends in the external events and the program code generating the scenarios based on the detected trends.

In some examples, the program code determining the scenarios relevant to the component comprises applying chain of reasoning factoring to the generated scenarios to determine which of the determined scenarios have greater probabilities of impacting the endpoint.

In some examples, the scenarios relevant to the component comprise scenarios above a pre-determined probability.

In some examples, the program code applying the reinforcement learning comprises: the program code generating visuals in a user interface of the scenarios relevant to the component, and the program code obtaining inputs from a user based on the visuals.

In some examples, the program code applying the reinforcement learning to the scenarios relevant to the component to validate the impacts of the scenarios comprises: the program code soliciting, via a user interface, input from a user, where the input validates the impacts.

In some examples, the program code selecting the most likely scenario comprises: based on the input from the user, the program code ranking the scenarios relevant to the component, and the program code selecting the highest ranked scenario.

In some examples, the program code generating the visuals comprises the program code integrating one or more aspects selected from the group consisting of: success metrics, benchmarks, and regulations, into the visuals.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method for revising process endpoints by updating strategies based on predicting impacts of exogenous events on original endpoints, comprising:
generating, by one or more processors, scenarios based on cognitively analyzing external events;
cognitively analyzing, by the one or more processors, the process and segmenting the process into components, for each component:
determining an endpoint for each component;
determining, by the one or more processors, the scenarios relevant to the component;
adjusting, by the one or more processors, the endpoint of the component based on the scenarios relevant to the component;
applying, by the one or more processors, reinforcement learning to the scenarios relevant to the component to validate impacts of the scenarios on the endpoint and to select a most likely scenario; and
implementing, by the one or more processors, process changes to terminate the component at the adjusted endpoint.

2. The computer-implemented method of claim 1, wherein the components comprise software and hardware engaged in an aspect of the process.

3. The computer-implemented method of claim 2, wherein the components comprise components of an enterprise computing system.

4. The computer-implemented method of claim 1, wherein cognitively analyzing the process and segmenting the process into the components comprises applying component business model methodology.

5. The computer-implemented method of claim 1, wherein generating the scenarios based on cognitively analyzing external events comprises utilizing a large language model to detect trends in the external events and generating the scenarios based on the detected trends.

6. The computer-implemented method of claim 1, wherein determining the scenarios relevant to the component comprises applying chain of reasoning factoring to the generated scenarios to determine which of the determined scenarios have greater probabilities of impacting the endpoint.

7. The computer-implemented method of claim 6, wherein the scenarios relevant to the component comprise scenarios above a pre-determined probability.

8. The computer-implemented method of claim 1, wherein applying the reinforcement learning comprises:
generating, by the one or more processors, visuals in a user interface of the scenarios relevant to the component; and
obtaining, by the one or more processors, inputs from a user based on the visuals.

9. The computer-implemented method of claim 1, wherein applying the reinforcement learning to the scenarios relevant to the component to validate the impacts of the scenarios comprises:
soliciting, by the one or more processors, via a user interface, input from a user, where the input validates the impacts.

10. The computer-implemented method of claim 9, wherein selecting the most likely scenario comprises:
based on the input from the user, ranking, by the one or more processors, the scenarios relevant to the component; and
selecting, by the one or more processors, the highest ranked scenario.

11. The computer-implemented method of claim 8, wherein generating the visuals comprises integrating one or more aspects selected from the group consisting of: success metrics, benchmarks, and regulations, into the visuals.

12. A computer system for revising process endpoints by updating strategies based on predicting impacts of exogenous events on original endpoints, the computer system comprising:
a memory; and
one or more processors in communication with the memory, wherein the computer system is configured to perform a method, said method comprising:
generating, by the one or more processors, scenarios based on cognitively analyzing external events;
cognitively analyzing, by the one or more processors, the process and segmenting the process into components, for each component:
determining an endpoint for each component;
determining, by the one or more processors, the scenarios relevant to the component;
adjusting, by the one or more processors, the endpoint of the component based on the scenarios relevant to the component;
applying, by the one or more processors, reinforcement learning to the scenarios relevant to the component to validate impacts of the scenarios on the endpoint and to select a most likely scenario; and
implementing, by the one or more processors, process changes to terminate the component at the adjusted endpoint.

13. The computer system of claim 12, wherein the components comprise software and hardware engaged in an aspect of the process.

14. The computer system of claim 13, wherein the components comprise components of an enterprise computing system.

15. The computer system of claim 12, wherein cognitively analyzing the process and segmenting the process into the components comprises applying component business model methodology.

16. The computer system of claim 12, wherein generating the scenarios based on cognitively analyzing external events comprises utilizing a large language model to detect trends in the external events and generating the scenarios based on the detected trends.

17. The computer system of claim 12, wherein determining the scenarios relevant to the component comprises applying chain of reasoning factoring to the generated scenarios to determine which of the determined scenarios have greater probabilities of impacting the endpoint.

18. The computer system of claim 17, wherein the scenarios relevant to the component comprise scenarios above a pre-determined probability.

19. The computer system of claim 12, wherein applying the reinforcement learning comprises:
generating, by the one or more processors, visuals in a user interface of the scenarios relevant to the component; and
obtaining, by the one or more processors, inputs from a user based on the visuals.

20. A computer program product for revising process endpoints by updating strategies based on predicting impacts of exogenous events on original endpoints, the computer system comprising:
one or more computer readable storage media and program instructions collectively stored on the one or more computer readable storage media readable by at least one processing circuit to:
generate scenarios based on cognitively analyzing external events;
cognitively analyze the process and segmenting the process into components, for each component:
determine an endpoint for each component;
determine the scenarios relevant to the component;
adjust the endpoint of the component based on the scenarios relevant to the component;
apply reinforcement learning to the scenarios relevant to the component to validate impacts of the scenarios on the endpoint and to select a most likely scenario; and
implement process changes to terminate the component at the adjusted endpoint.
